(19) United States
(12) Patent Application Publication
(10) Pub. No.: US 2012/0219721 A1
(43) Pub. Date: Aug. 30, 2012

(54) METHOD FOR PRODUCING FILMS HAVING PARTICLE-CONTAINING LAYER

(76) Inventors: Kenichi Yasuda, Minami-Ashigara-shi (JP); Takehiko Harasawa, Minami-Ashigara-shi (JP); Atsushi Osao, Fujinomiya-shi (JP); Tomohiro Kudo, Fujinomiya-shi (JP)

(21) Appl. No.: 13/406,326

(22) Filed: Feb. 27, 2012

Related U.S. Application Data
(60) Provisional application No. 61/494,144, filed on Jun. 7, 2011.

(30) Foreign Application Priority Data
Feb. 28, 2011 (JP) 2011-042510

(51) Int. Cl. B05D 1/12

(52) U.S. Cl. 427/424

(57) ABSTRACT

Method of producing a film having a particle-containing layer, comprising the steps of:
preparing a coating fluid in a tank, the coating fluid containing particles;
conveying the coating fluid from the tank, discharging the coating fluid, and supplying the coating fluid to a supply port of a coating head including a manifold and a slot, the manifold having the supply port and a discharge port;
supplying the coating fluid from the slot of the coating head to a continuously-running support; and
suctioning part of the coating fluid from the discharge port of the manifold of the coating head by using a reciprocating pump including a non-return valve and discharging a pulsating flow from the reciprocating pump,
wherein pressure adjustment is made so that a pressure on a discharge side of the reciprocating pump is always higher than a pressure on a suction side.

### CROSS-REFERENCE TO RELATED APPLICATION

This non-provisional application claims priority under U.S.C. §119(e) of U.S. Provisional Application Ser. No. 61/494,144, filed on Jun. 7, 2011.

### BACKGROUND OF THE INVENTION

1. Field of the Invention

The present invention relates to a method of producing a film having a particle-containing layer and, in particular, to a method of producing a film having a particle-containing layer by applying a coating fluid containing particles to a continuously-running support (called a “web”).

2. Description of the Related Art

To apply a coating fluid quickly and thinly to a web surface, an extrusion-type coating apparatus is generally used. An example of a method of conveying the coating fluid to a coating head of the coating apparatus is a drawing scheme. In this drawing scheme, a supply pump is provided to a supply system communicating with a coating head, and the coating fluid is supplied by this supply pump onto the coating head. Also, a drawing pump is provided to a drawing system communicating the coating head, and part of the coating fluid is extracted from the coating head by the drawing pump. With this, the web is coated, with a difference between the amount of fluid supplied to the coating head and the amount of drawing from the coating head being taken as an amount of coating.

In the drawing scheme, the pressure on an inlet side of the drawing pump becomes negative, thereby possibly causing cavitation. To prevent this, Japanese Patent Application Laid-Open No. 2002-045761 discloses that the pressure on a discharge side and the pressure on a suction side of the drawing pump have a predetermined relation in consideration of the pressure of a coating unit.

However, when the coating fluid containing particles is applied, the type of pump for use is limited. For this reason, there is a problem in which fluid fluctuations cannot be suppressed only by regulating the pressure relation.

Japanese Patent Application Laid-Open No. 8-215626 discloses that, to apply the coating fluid containing particles, the coating fluid is partly extracted from a manifold of the coating head, and is again circulated to the coating head to cause a flow of the coating fluid in the coating head, thereby preventing sedimentation of the particles. With this, the particles are uniformly dispersed in the coating fluid to prevent irregularities in coating. However, no method of stabilizing the velocity of flow is described, and it is disadvantageously not known how the amount of fluid flow outputted from the manifold is stabilized. When the amount of fluid flow is not stabilized, the fluid containing particles sediments at a portion where the velocity of flow is slow. This sedimentation occurs in the manifold and, when clumps of the sedimented particles become large, the flow of the coating fluid in a slot is affected to cause a local distribution of the amount of coating fluid, which becomes apparent as a surface failure (stripe). Therefore, it is required to stop the supply of the fluid and to perform cleaning before sedimentation in the fluid-supply manifold of the coating head greatly grows.

### SUMMARY OF THE INVENTION

The present invention has been made to solve the problems above, and has an object of providing a method of producing a film having a particle-containing layer, the method capable of preventing sedimentation of the particles in a manifold of a coating head.

A first aspect of the present invention is directed to a method of producing a film having a particle-containing layer, the method at least including the steps of: preparing a coating fluid in a tank, the coating fluid having a viscosity equal to or lower than 20 mPa·s and containing particles each having a particle diameter equal to or larger than 0.5 μm; conveying the coating fluid from the tank so that an amount of fluid conveyance is substantially constant, discharging the coating fluid, and supplying the coating fluid to a supply port of a coating head including a manifold and a slot, the manifold having the supply port and a discharge port; supplying the coating fluid from the slot of the coating head to a continuously-running support; and suctioning part of the coating fluid from the discharge port of the manifold of the coating head by using a reciprocating pump including a non-return valve so that an amount of suction is substantially constant and discharging a pulsating flow from the reciprocating pump, wherein pressure adjustment is made so that a pressure on a discharge side of the reciprocating pump is always higher than a pressure on a suction side.

According to a second aspect of the present invention, in the method of producing a film having a particle-containing layer according to the first aspect, the pressure adjustment is performed by a throttle mechanism provided on the suction side and/or the discharge side of the reciprocating pump.

According to a third aspect of the present invention, in the method of producing a film having a particle-containing layer according to the second aspect, with the throttle mechanism, a flow-path sectional area is narrowed down by 40% or lower of a flow-path sectional area prior to the throttle mechanism, and a length of a narrowed-down portion in a flow-path direction is equal to or longer than a longitudinal diameter of a throttling part of the throttle mechanism.

According to a fourth aspect of the present invention, in the method of producing a film having a particle-containing layer according to the second aspect, an outlet and/or an inlet of the throttle mechanism is formed in a tapered shape.

According to a fifth aspect of the present invention, in the method of producing a film having a particle-containing layer according to the second aspect, pulsation absorption is performed by an elastic body between the reciprocating pump and the throttle mechanism provided on the discharge side of the reciprocating pump.

According to the method of producing a film having a particle-containing layer, the coating fluid containing particles is conveyed so that the fluid-conveying amount is substantially constant, and is suctioned by the reciprocating pump from the coating head by a predetermined amount of suction. With this, sedimentation of the particles in the manifold of the coating head can be prevented.

### BRIEF DESCRIPTION OF THE DRAWINGS

FIG. 1 is a schematic structural diagram of an antiglare film;

FIG. 2 is a schematic structural diagram showing a line of producing a film having a particle-containing layer;

FIG. 3 is a schematic diagram showing a method of producing a film having a particle-containing layer;

FIG. 4 is a schematic structural diagram of a coating system;

FIG. 5 is a schematic structural diagram of a reciprocating pump;

FIG. 6 is a waveform diagram of an amount of discharge of the reciprocating pump;

FIG. 7 is a schematic diagram of a thin piping;

FIG. 8 is a schematic structural diagram of a pulsation absorbing mechanism; and

FIG. 9 is a table summarizing conditions and evaluations of examples.

### DETAILED DESCRIPTION OF THE PREFERRED EMBODIMENTS

Preferred embodiments of the present invention are described below according to the attached drawings. While the present invention is described based on the preferred embodiments below, modifications can be made with various techniques without deviating from the scope of the present invention, and embodiments other than the present embodiments can also be used. Therefore, all modifications within the scope of the present invention are included in the claims.

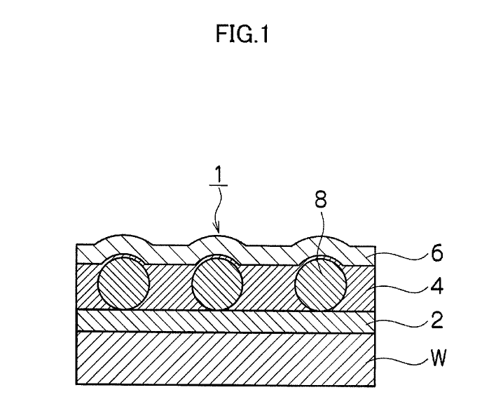

FIG. 1 shows a basic structure of an antiglare film as an example of a film having a particle-containing layer. An anti-glare film 1 has a web W, a hard coat. layer 2, an anti-glare layer 4, and a low-refractive-index layer 6 in this order. The anti-glare layer 4 contains particles 8. With the particles 8, asperities are formed on a surface of the anti-glare layer 4. With the asperities on the surface, anti-glare characteristics are achieved. Note that examples of a film having a particle-containing layer include a dispersion film, a diffusion film, and a material sheet to be recorded for inkjet, in addition to the anti-glare film.

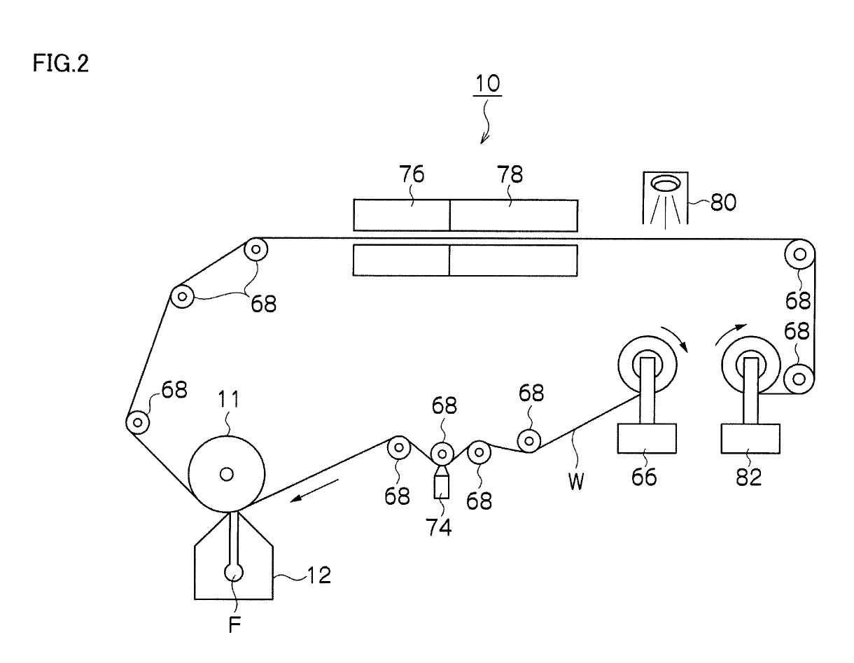

FIG. 2 is a structural diagram of a line of producing a film having a particle-containing layer. A producing line 10 includes a delivery machine 66, a dust removal machine 74, a slot die 12, which is a coating head of an extrusion type, a drying zone 76, a heating zone 78, an ultraviolet lamp 80, and a winding-up machine 82.

First, the web W is delivered from the delivery machine 66. The web W is guided by a guide roller 68, and is fed to the dust removal machine 74. The dust removal machine 74 removes dust attached onto a surface of the web W. In a downstream of the dust removal machine 74, the slot die 12, which is a coating head of an extrusion-type, is arranged. At a position facing the slot die 12, a backup roller 11 is arranged. With the continuously-running web W being supported by the backup roller 11, a coating fluid F containing particles is supplied from the slot die 12. A coating containing particles are formed on the web W.

The web W having the coating containing the particles is transported via the drying zone 76 and the heating zone 78 to the ultraviolet lamp 80. With the ultraviolet lamp 80, ultraviolet rays are applied to cure the coating containing the particles to form a particle-containing layer. The web W having the particle-containing layer is wound up by the winding-up machine 82.

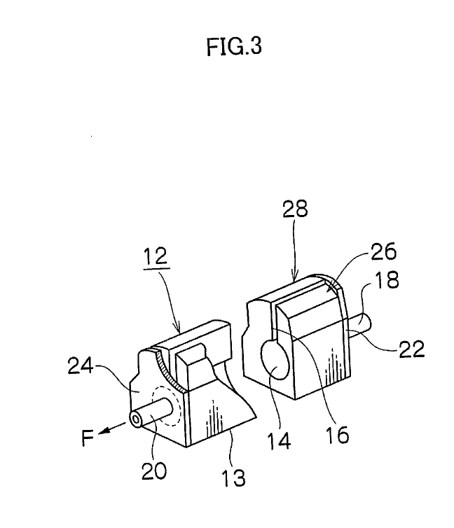

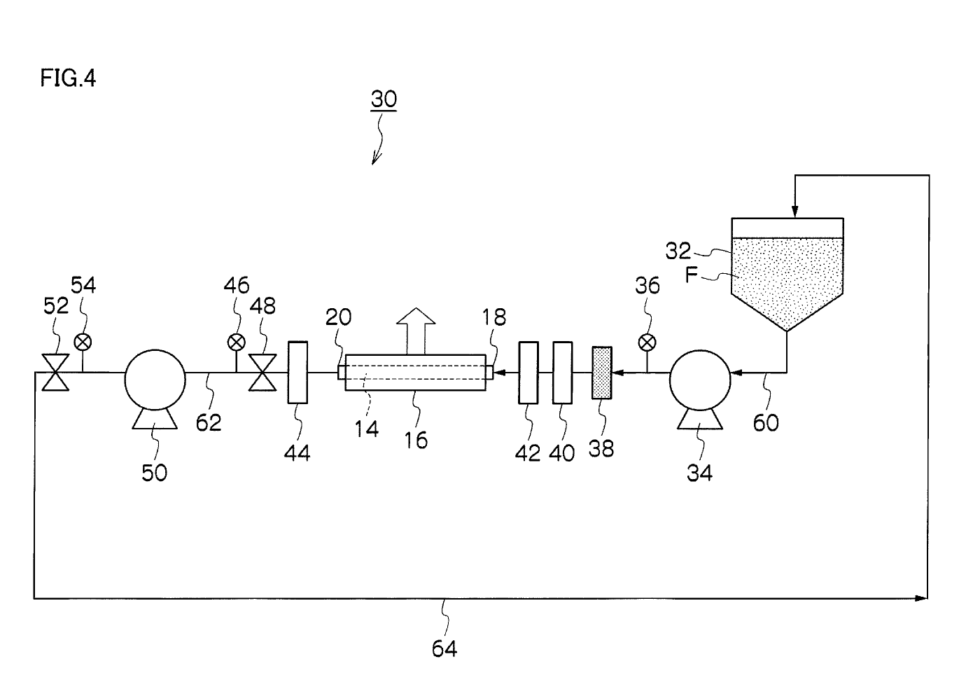

FIG. 3 is a perspective view with part of the slot die being cut out. FIG. 4 shows an entire structure of the coating system for applying the particle-containing coating fluid from the slot die onto the web W.

As shown in FIG. 3, the slot die 12 includes a manifold 14 provided inside of a main body, a slot 16 communicating with the manifold 14, a supply port 18 supplying a coating fluid F to the manifold 14, and a discharge port 20 for drawing the coating fluid F from the manifold 14. The slot die 12 is configured of two die blocks 26 and 28. The manifold 14 and the slot 16 are formed by arranging two die blocks 26 and 28 each with a cavity formed therein so that they face each other. A both-end opening penetrating through the manifold 14 is closed with closing plates 22 and 24 mounted at both ends. Note that the supply port 18 is provided to the closing plate 22 and the discharge port 20 is provided to the closing plate 24.

As shown in FIG. 4, a coating system 30 includes a stock tank 32 storing the particle-containing coating fluid F, a supply piping 60 making the stock tank 32 and the slot die 12 communicate with each other for supplying the coating fluid F to the slot die 12, a drawing piping 62 communicating with the slot die 12 for drawing part of the coating fluid F from the slot die 12, and a circulating piping 64 making the drawing piping 62 and the stock tank 32 communicate with each other for returning the drawn coating fluid F to the stock tank 32. Note that when the coating fluid F drawn through the drawing piping 62 is discarded, the circulating piping 64 does not have to be installed.

In the supply piping 60, a pump 34, a pressure gauge 36, a filter 38, a flowmeter 40, and a buffer tank 42 are arranged in this order from the stock tank 32 toward the slot die 12.

In the drawing piping 62, a flowmeter 44, a first throttle mechanism 48, a pressure gauge 46, a reciprocating pump 50 including a non-return valve, a pressure gauge 54, and a second throttle mechanism 52 are arranged in this order from the slot die 12 toward the circulating piping 64.

In the stock tank 32, the particle-containing coating fluid F is stored. With the pump 34, the coating fluid F is conveyed from the stock tank 32 to the supply port 18 of the slot die 12 via the filter 38. The pump 34 discharges a substantially constant amount of discharge of the coating fluid F. With the amount of discharge being constant, the occurrence of stepwise irregularities due to pulsation can be suppressed. Note that the pump 34 does not have to be used as long as the amount of fluid supply to the slot die can be made constant. The fluid may be conveyed by using a gravity drop from the tank.

Part of the coating fluid F is drawn by the reciprocating pump 50 including the non-return valve from the discharge port 20 of the slot die 12. The reciprocating pump 50 suctions part of the coating fluid F in the substantially constant suction amount. With the suctioning amount being constant, the occurrence of stepwise irregularities due to pulsation can be suppressed. However, while stepwise irregularities due to pulsation can be suppressed, an unexpected new problem occurs in which the amount of coating is gradually decreased with time.

As a result of diligent studies by the inventors, the occurrence of the following phenomenon has been clarified. When the reciprocating pump 50 including the non-return valve suctions the coating fluid F in a substantially constant amount, the suctioned coating fluid F cannot be discharged in a constant amount. That is, pulsation occurs on a discharge side of the reciprocating pump 50, thereby causing the fluid pressure to fluctuate. When the fluid pressure on a pump discharge side decreases, it becomes below the fluid pressure on a pump suction side. Then, the coating fluid leaks from the suction side to the discharge side. When the coating fluid leaks to the discharge side, the amount of coating decreases.

What is important to solve the above-described new problem is to always make the fluid pressure on the discharge side of the reciprocating pump 50 higher than the pressure on the suction side. When the flow rate on the suction side of the reciprocating pump 50 is made substantially constant, the flow rate and the fluid pressure on the discharge side fluctuate. The amount of fluctuation of the fluid pressure on the discharge side of the reciprocating pump 50 is changed depending on the physical properties of the fluid regarding fluid inertial force and the shape of a fluid-conveying system (length and thickness) and others. At any rate, in consideration of these fluctuations in fluid pressure on the discharge side of the reciprocating pump 50, the pressure on the discharge side is made always higher than the pressure on the suction side, thereby preventing a leak of the coating fluid F at the time of operation of the reciprocating pump 50. In order to reliably prevent a leak even if some disturbance is added to the fluid conveying system, the lowest pressure value on the discharge side is preferably adjusted to be always higher than the pressure on the suction side by 10 kPa.

To make the pressure on the discharge side higher than the pressure on the suction side, the first throttle mechanism 48 and/or the second throttle mechanism 52 is installed on the suction side of the reciprocating pump 50 and/or on the discharge side of the reciprocating pump 50. The pressure in the drawing piping 62 is adjusted by the first throttle mechanism 48 and/or the second throttle mechanism 52. By throttling the flow path, the pressure can be made high on an upstream side of the first throttle mechanism 48 and made low on a downstream side thereof, and can be made high on an upstream side of the second throttle mechanism 52 and made low on a downstream side thereof. As a result, the pressure on the discharge side of the reciprocating pump 50 can be adjusted to be always higher than the pressure on the suction side of the reciprocating pump 50.

As the first throttle mechanism 48 and/or the second throttle mechanism 52, a ball valve, a gate valve, or a butterfly valve can be used.

However, when the particles contained in the coating fluid F are large, there is a possibility that the throttle mechanism is clogged with the particles. To avoid this problem, a piping or a back pressure valve having an inner diameter (for example, φ2 mm) larger than a particle diameter and having a length (for example, 30 mm) equal to or longer than a predetermined value is preferably used.

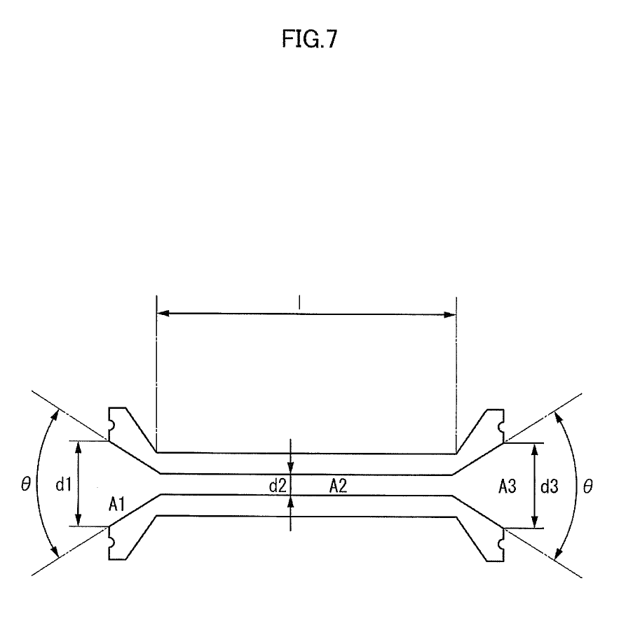

Next, the shape and size of a fine piping for use in the present embodiment are described. FIG. 7 shows an example of a model of the fine piping. Calculating a pressure loss when the fluid flows from left to right is known as a method of calculating a pressure loss of a flow path (for example, refer to Fluid Resistance of Pipeline and Duct, Japan Society of Mechanical Engineers, 1979). It is assumed that an inlet pipeline diameter is d1, an inlet sectional area is A1, a capillary pipeline diameter is d2, a fine-piping sectional area is A2, a length in a flow-path direction is l, an outlet pipeline diameter is d3, an outlet sectional area is A3, and a taper angle of the inlet and the outlet is θ. When it is assumed that loss heads of the inlet, the fine piping, and the outlet are h1, h2, and h3, respectively, it is known that the following equation holds, with loss factors of the inlet and the outlet being δᵢₙ and δₒᵤₜ, a pipe coefficient of friction of the fine piping being λ, and a flow of the fine piping being taken as a laminar flow.

$$\begin{matrix}( Inlet Loss Head ) \\ {h}_{1} = {δ}_{in} \frac{{v}_{2}^{2}}{2 g} & [ Equation 1 ] \\ ( Fine \text{-} Piping Loss Head ) \\ {h}_{2} = λ \frac{l}{{d}_{2}} \frac{{v}_{2}^{2}}{2 g} \\ λ = \frac{64}{Re} ( Re < 2300 ) & [ Equation 2 ] \\ ( Outlet Loss Head ) \\ {h}_{3} = {δ}_{out} \frac{{v}_{1}^{2}}{2 g} & [ Equation 3 ]\end{matrix}$$

Based on this shape, when the calculation is made with δᵢₙ=0.04 and δₒᵤₜ=1.06, a pressure loss (increase in fluid pressure) of 5 kPa is obtained in the following cases. That is, when the drawing flow rate is 1.2 L/minute and the viscosity of the fluid is 7 mPa·s, the length is on the order of 14 mm with a fine piping diameter of φ3 mm. With a fine piping diameter of φ2.5 mm, the length is on the order of 38 mm when the drawing flow rate is 0.6 L/minute and the viscosity of the fluid is 7 mPa·s. In this manner, the diameter of the fine piping and the length of a fine portion can be designed according to the necessary amount of increase in fluid pressure.

Note that the outlet and/or inlet of the fine piping is preferably provided with a taper as described above. Although the pressure loss is larger without any taper provided to the outlet and/or inlet, a retention part of the coating fluid tends to occur, thereby possibly causing sedimentation and coagulation of particles. When particles coagulate, further means is required, such as that for cleaning that portion. To prevent this from occurring, it is effective to provide a taper to the outlet and/or inlet of the fine piping.

The capillary pipeline diameter (a longitudinal diameter) d2 of the fine piping and the length l in the flow-path direction preferably have a relation of l>d2.

As pulsation and fluctuations in fluid pressure on the discharge side of the reciprocating pump 50 is larger, the fluid pressure minimum value on the discharge side is lower, and becomes prone to go below the fluid pressure on a suction side. To prevent this, the first throttle mechanism 48 and/or the second throttle mechanism 52 is throttled stronger, thereby causing the throttle mechanism 52 to be prone to be clogged with particles. Thus, providing a mechanism that suppresses pulsation and fluctuations in fluid pressure on the discharge side of the reciprocating pump 50 is also preferable. For example, a fine piping with a structure partially provided with an elastic material can be used.

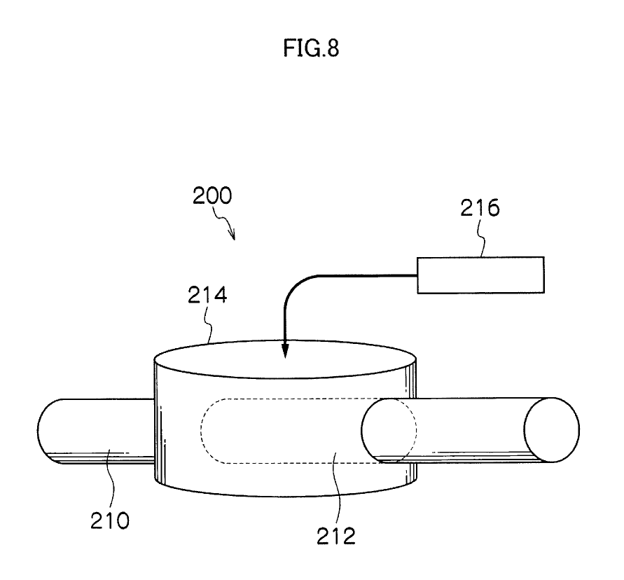

FIG. 8 is a schematic structural diagram of a piping partially provided with an elastic material. A pulsation absorbing mechanism 200 includes a piping 210, and part of the piping 210 is configured of an elastic member 212 as represented by a dotted line. Furthermore, an air chamber 214 surrounding the perimeter of this elastic member 212 is provided. The air chamber 214 communicates with air supply means 216. The air supply means 216 supplies air to the air chamber 214.

The pulsation absorbing mechanism 200 is installed on the discharge side of the reciprocating pump 50. When the reciprocating pump 50 discharges a pulsating flow, the pressure in the piping 210 increases. This increase in pressure is absorbed by the elastic member 212. With this, pulsation can be suppressed.

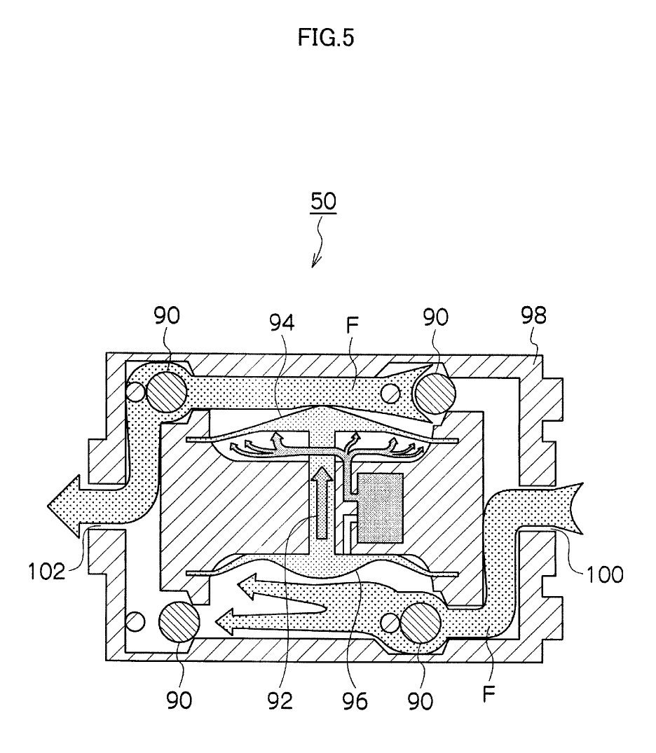

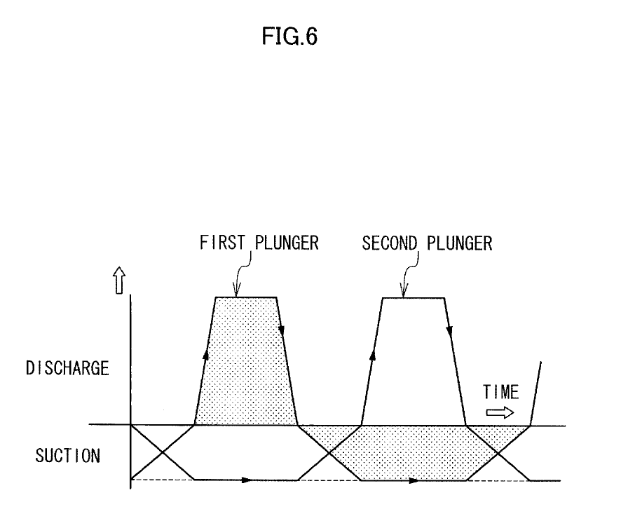

Next, the reciprocating pump 50 is described with reference to FIG. 5 and FIG. 6. FIG. 5 schematically shows the structure of the reciprocating pump 50. As an example of the reciprocating pump, a diaphragm-type reciprocating pump is shown. The pump 34 and the reciprocating pump 50 each includes a center rod 92, a first diaphragm 94 and a second diaphragm 96 installed at both ends of the center rod 92, and a housing 98 having these components accommodated therein. The housing 98 includes a suction port 100 for suction of the coating fluid F and a discharge port 102 for discharge of the coating fluid F.

As shown in FIG. 5, compressed oil is supplied to a first diaphragm 94 side. With the compressed oil, the center rod 92 is moved, and the coating fluid F on the first diaphragm 94 side is discharged from the discharge port 102. Simultaneously, the second diaphragm 96 is also moved to suction the coating fluid F via the suction port 100 to a second diaphragm side.

Next, compressed oil is supplied to the second diaphragm 96 side. With the compressed oil, the center rod 92 is moved, and the coating fluid F on the second diaphragm 96 side is discharged from the discharge port 102. Simultaneously, the first diaphragm 92 is also moved to suction the coating fluid F via the suction port 100 to a first diaphragm side. In this manner, the coating fluid F is continuously suctioned and discharged.

To prevent a leak of the coating fluid F, two catch balls 90 are placed on the suction port 100 side, and two catch balls 90 are placed on the discharge port 102 side. This fluid leakage preventive mechanism is referred to as a non-return valve.

Note that timing of suction and discharge is controlled by rotating a cam (not shown).

In the diaphragm-type reciprocating pump 50, to reliably prevent a leak, the pressure on a discharge port 102 side is required to be higher than the pressure on the suction port 100 side.

For the reciprocating pump 50, by installing the first throttle mechanism 48 and and/or the second throttle mechanism 52, the pressure on the discharge side is always made higher than the pressure on the suction side.

As an example of the reciprocating pump, a diaphragm-type reciprocating pump is shown. However, this is not meant to be restrictive, and a piston-type reciprocating pump, a plunger-type reciprocating pump, or the like can be used.

FIG. 6 is a waveform diagram of the amount of discharge of the reciprocating pump. In the waveform diagram of FIG. 6, the vertical axis represents an amount of discharge and an amount of suction of the coating fluid, and the horizontal axis represents time.

As shown in FIG. 6, in the reciprocating pump 50, a first plunger (a first diaphragm) and a second plunger (a second diaphragm) alternately and continuously operate. The first plunger and the second plunger operate so that a total of the amount of suction by the first plunger and the amount of suction by the second plunger is constant. With this, in the state where pulsation is substantially prevented from occurring, the coating fluid F is drawn from the slot die 12.

With the operation of the pump 34 having the constant amount of fluid conveyance and the reciprocating pump 50, the velocity of flow is constant in the manifold 14 of the slot die 12. Therefore, particles are prevented from sedimenting in the manifold 14.

Next, a material for use in producing a film having a particle-containing film is described.

<Support (Web)>

As an example of the support, a plastic film is preferably used. Examples of a polymer forming the plastic film include cellulose acylate (for example, triacetylcellulose and diacetylcellulose, typically TAC-TD80U, TD80UF, and others manufactured by FUJIFILM CORPORATION), polyamide, polycarbonate, polyester (for example, polyethylene terephthalate and polyethylene naphthalate), polystyrene, polyolefin, norbornene-based resin (ARTON: product name, manufactured by JSR Corporation), amorphous polyolefin (ZEONEX: product name, manufactured by ZEON Corporation), and (metha)acryl-based resin (ACRYPET VRL20A: product name, manufactured by Mitsubishi Rayon Co., Ltd., ring-system-containing acrylic-based resin described in Japanese Patent Application Laid-Open Nos. 2004-70296 and 2006-171464). Among these, triacetylcellulose, polyethylene terephthalate, and polyethylene naphthalate are preferable and, in particular, triacetylcellulose is preferable.

<Coating Fluid>

The coating fluid contains an organic solvent, particles, and a binder polymer. When the coating fluid has a low viscosity (for example, when the viscosity is equal to or lower than 20 mPa·s), particles tend to sediment, and therefore the present invention achieves a significant effect.

(Organic Solvent)

Examples of the organic solvent include alcohol-based ones such as methanol, ethanol, n-propanol, isopropanol, n-butanol, isobutanol, secondary butanol, terntiary butanol, isoamylalcohol, 1-pentanol, n-hexanol, and methylamylalcohol; ketone-based ones, such as methylisobutylketone, methylethylketone, diethylketone, acetone, cyclohexanone, and diacetonealcohol; ester-based ones such as methylacetate, ethylacetate, n-propylacetate, isopropylacetate, isobutylacetate, n-butylacetate, isoamylacetate, n-amylacetate, methylpropionate, ethylpropionate, methylbutyrate, ethylbutyrate, methyllactate, ethyllactate, and ether; acetal-based ones such as 1,4 dioxane, tetrahydrofuran, 2-methylfuran, tetrahydropyran, and diethylacetal; hydrocarbon-based ones such as hexane, heptane, octane, isooctane, ligroin, cyclohexane, methylcyclohexane, toluene, xylene, ethyl benzene, styrene, and divinylbenzene; halogen-hydrocarbon-based ones such as carbon tetrachloride, chloroform, methylene chloride, ethylene chloride, 1,1,1-trichloroethane, 1,1,2-trichloroethane, trichloroethylene, tetrachloroethylene, and 1,1,1,2-tetrachloroethane; polyalcohol and its derivative-based ones such as ethylene glycol, ethyleneglycolmonomethylether, ethyleneglycolmonoethylether, ethyleneglycolmonoacetate, diethyleneglycol, propyleneglycol, dipropyleneglycol, butanediol, hexyleneglycol, 1,5-pentanediol, glycerolmonoacetate, glycerolethers, and 1,2,6-hexanetriol; fatty-acid-based ones such as formic acid, acetic acid, propionic acid, butyric acid, isobutyric acid, isovaleric acid, and lactic acid; nitrogen-compound-based ones such as formamide, N,N-dimethylformamide, acetamide, and acetonitrile; and sulfur-compound-based ones such as dimethylsulfoxide.

Among the organic solvents, methylisobutylketone, methylethylketone, cyclohexane, acetone, toluene, xylene, ethylacetate, 1-pentanol, and others are particularly preferable. Also, into the organic solvent, alcohol-based or polyalcohol-based solvent may be mixed as appropriate in order to control coagulation properties. These organic solvents may be singly mixed, and the coating composite preferably contains 20 mass percent to 90 mass percent as a total amount of organic solvents, more preferably 30 mass percent to 80 mass percent, and most preferably 40 mass percent to 70 mass percent. To stabilize the surface shape of the particle-containing layer, a solvent with a boiling point lower than 100° C. and a solvent with a boiling point higher than 100° C. are preferably used together.

(Particles)

As specific examples of particles dispersed in the particle-containing layer, resin particles are preferable, such as crosslinked polymethylmethaacrylate, a crosslinked methylmethaacrylate-styrene copolymer, a crosslinked methylmethaacrylate-methylacrylate copolymer, a crosslinked acrylate-styrene copolymer, crosslinked polystyrene particles, a crosslinked methylmethaacrylate-crosslinked modified acrylate copolymer, melamine-formaldehyde resin particles, and benzoguanamine-formaldehyde resin particles. Among these, crosslinked polymethylmethaacrylate, a crosslinked methylmethaacrylate-styrene copolymer, and others are preferable.

The particle size distribution is measured by a Coulter counter method, and the measured distribution is converted to a particle count distribution. The average particle diameter can be calculated from the obtained particle distribution or can be measured by a light scattering method or an electron micrograph.

Since particles tend to sediment in the binder, an inorganic filler such as silica may be added in order to prevent sedimentation. Note that as the amount of addition of the inorganic filler is increased, sedimentation of translucent particles can be more effectively prevented, but transparency of the coating is adversely affected. Therefore, preferably, approximately 0.1 mass percent or less inorganic filler having a particle diameter equal to or smaller than 0.5 μm can be contained in the binder to an extent that transparency of the coating is not impaired.

As specific examples of these particles, commercially-available resin particles can be used, such as Chemisnow, MX600, MX675, RX0855, MX800, SX713L, and MX1500H manufactured by Soken Chemical & Engineering Co., Ltd., and TECHPOLYMER, SSX108HXE, SSX108LXESSX-106TN, SSX-106FB, and XX120S manufactured by Sekisui Plastics Co., Ltd.

(Binder Polymer)

As a binder polymer forming a matrix, although not particularly restrictive, a translucent binder polymer having a saturated hydrocarbon chain or a polyether chain as a main chain after curing by ionizing radiation is preferable. Also, a main binder polymer after curing preferably has a crosslink structure. Note that the binder polymer preferably constitutes 55 mass percent to 94 mass percent in the antiglare layer (as a solid), and further preferably 75 mass percent to 90 mass percent.

As a binder polymer having a saturated hydrocarbon chain as a main chain after curing, an ethylenic unsaturated monomer selected from a first group of compounds described below and a polymer thereof are preferable. Also as a polymer having a polyether chain as a main chain, an epoxy-based monomer selected from a second group of compounds described below and a polymer of an open loop thereof. Furthermore, a polymer of a mixture of these monomers is also preferable.

The polymerization initiator is used in a range from 0.1 mass percent to 15 mass percent as a total amount of the polymerization initiator with respect to 100 mass percent the monomer and, more preferably in a rang from 1 mass percent to 10 mass percent.

### EXAMPLES

The present invention is described below by listing examples. However, the present invention is not restricted to these.

### Composition of the Coating Fluid F

8 μm-particle-dispersed fluid

CAB: cellulose acetate butyrate

Methyl isobutyl ketone (MIBK)

Methyl ethyl ketone (MEK)

Binder

Viscosity of the Coating Fluid: 8 mPa·s, Specific Gravity: 0.958

The stock tank, the fluid-conveying pump, the filter manufactured by Pall, the flowmeter (manufactured by Endless-Hauser), the buffer tank for absorbing bubbles and pulsation, the slot die, the flowmeter (manufactured by Emerson), the first throttle mechanism, the pressure gauge, the drawing pump (the reciprocating pump), the pressure gauge, the second throttle mechanism, and the circulating pump were arranged in this order to assemble a coating system.

The fluid-conveying pump and the drawing pump having the same structure were used. However, regarding the control of the timing of suction and discharge, the fluid-conveying pump and the drawing pump are different in rotating direction of the cam. Rotation of the cam of the fluid-conveying pump with a constant amount of discharge is referred to as forward rotation, and rotation of the cam of the drawing pump with a constant amount of suction is referred to as counter-rotation.

From the fluid-conveying pump, the coating fluid is supplied to the slot die. The amount of supply of the coating fluid is a total of an amount of coating onto the web and an amount of drawing from the drawing pump. With the amount of fluid conveyance to the web being taken as constant at 2117 cc/minute, the drawing pump was driven at a high velocity of flow required for preventing sedimentation of particles (refer to Japanese Patent Application Laid-Open No. 2009-72689).

The amount of drawing was adjusted by adjusting the number of operating revolutions of the drawing pump. Accordingly, the fluid-conveying pump was driven with an amount of supply of 2217 cc/minute to 3117 cc/minute. As a first throttle mechanism for adjusting the pressure prior to the drawing pump, a fine piping was used.

As the second throttle mechanism for adjusting the pressure subsequent to the drawing pump, a gate valve, a fine piping with a narrow piping diameter, a back pressure valve, a fine piping partially using an elastic material, or the like was used. As a throttle mechanism for simply increasing the fluid pressure, a gate valve or the like can be used. As a mechanism for preventing clogging of coagulated particles while increasing the fluid pressure, a fine piping with a narrow piping diameter can be used. Also, as a method of increasing the fluid pressure including a mechanism for absorbing pulsation on the discharge side, a method can be used in which part of the back pressure valve or the fine piping is partially formed of an elastic body. The fluid-pressure increasing means described above and a known fluid-conveying pulsation absorbing mechanism (for example, Japanese Patent Application Laid-Open No. 2010-78004) may be combined for use.

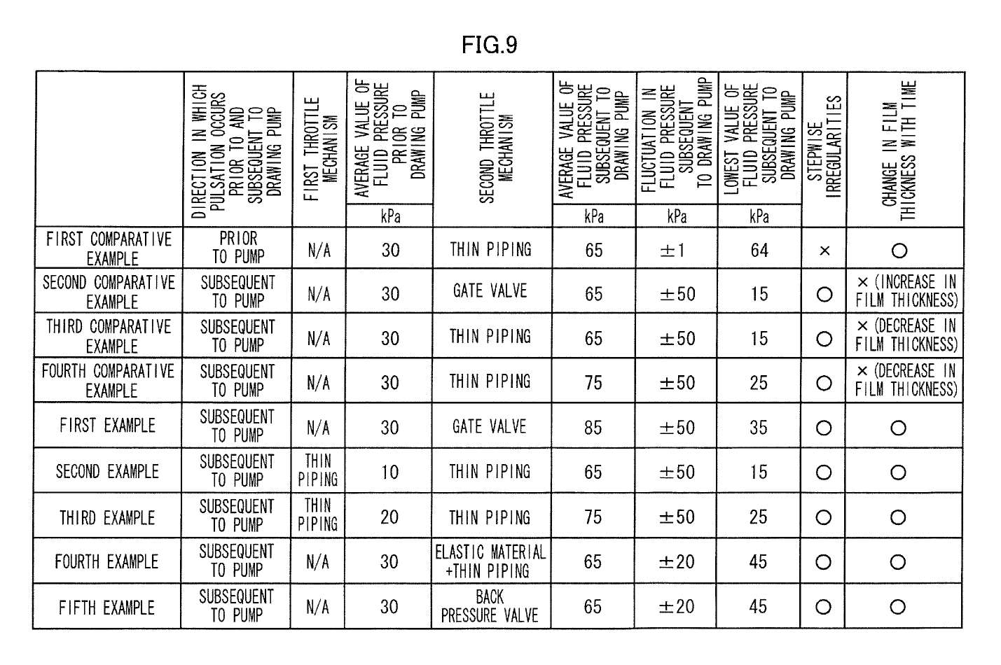

A table shown in FIG. 9 provides a summary of types of throttle mechanisms, pressures prior to and subsequent to the drawing pump, fluctuations in pressure, stepwise irregularities, changes in film thickness with time. In stepwise irregularities, a circle represents that fluctuations in film thickness is within 1.5%. In changes in film thickness of fluid conveyance with time, a circle represents that fluctuations is within 0.01%/h.

In first to fifth examples, the following conditions are satisfied: (1) the amount of drawing of the drawing pump is constant, and (2) regarding the pressures prior to and subsequent to the drawing pump, the pressure on the discharge side is always higher than the pressure on the suction side. Therefore, stepwise irregularities and changes in film thickness with time are both marked with a circle (evaluated as good or better).

In a first comparative example, the amount of drawing is not constant, that is, pulsation occurs prior to the drawing pump, and therefore stepwise irregularities is marked with a cross (not good). In second to fourth comparative examples, the minimum value of the fluid pressure subsequent to the drawing pump may be lower than an average value of the fluid pressure prior to the drawing pump according to fluctuations in fluid pressure. As a result, changes in film thickness with time is marked with a cross (not good).

What is claimed is:

1. A method of producing a film having a particle-containing layer, comprising the steps of:
preparing a coating fluid in a tank, the coating fluid having a viscosity equal to or lower than 20 mPa·s and containing particles each having a particle diameter equal to or larger than 0.5 μm;
conveying the coating fluid from the tank so that an amount of fluid conveyance is substantially constant, discharging the coating fluid, and supplying the coating fluid to a supply port of a coating head including a manifold and a slot, the manifold having the supply port and a discharge port;
supplying the coating fluid from the slot of the coating head to a continuously-running support; and
suctioning part of the coating fluid from the discharge port of the manifold of the coating head by using a reciprocating pump including a non-return valve so that an amount of suction is substantially constant and discharging a pulsating flow from the reciprocating pump,
wherein pressure adjustment is made so that a pressure on a discharge side of the reciprocating pump is always higher than a pressure on a suction side.

2. The method of producing a film having a particle-containing layer according to claim 1, wherein the pressure adjustment is performed by a throttle mechanism provided on at least one of the suction side and the discharge side of the reciprocating pump.

3. The method of producing a film having a particle-containing layer according to claim 2, wherein with the throttle mechanism, a flow-path sectional area is narrowed down by 40% or lower of a flow-path sectional area prior to the throttle mechanism, and a length of a narrowed-down portion in a flow-path direction is equal to or longer than a longitudinal diameter of a throttling part of the throttle mechanism.

4. The method of producing a film having a particle-containing layer according to claim 2, at least one of an outlet and an inlet of the throttle mechanism is formed in a tapered shape.

5. The method of producing a film having a particle-containing layer according to claim 2, wherein pulsation absorption is performed by an elastic body between the reciprocating pump and the throttle mechanism provided on the discharge side of the reciprocating pump.
